(19) United States
(12) Patent Application Publication
(10) Pub. No.: US 2024/0017334 A1
(43) Pub. Date: Jan. 18, 2024

(54) POWER TOOL WITH LIFTOFF PROTECTION

(71) Applicant: Apex Brands, Inc., Apex, NC (US)

(72) Inventors: Jeremy Dean Watford, Irmo, SC (US); Dwayne Robert Fisher, Lexington, SC (US)

(21) Appl. No.: 18/030,810

(22) PCT Filed: Oct. 8, 2021
(86) PCT No.: PCT/US2021/054273

§ 371 Date: Apr. 7, 2023

Related U.S. Application Data
(60) Provisional application No. 63/089,852, filed on Oct. 9, 2020.

(51) Int. Cl. B23B 47/32; B23B 45/02

(52) U.S. Cl. CPC B23B 47/32; B23B 45/02

(57) ABSTRACT

A power tool may include a motor, a controller configured to control operation of the motor, a drill assembly configured to control operation of a cutter with respect to a workpiece responsive to operation of the motor, and a liftoff protection assembly. The liftoff protection assembly may be configured to detect a trigger event associated with movement of the power tool relative to the workpiece, and initiate a protective action for the power tool responsive to the trigger event.

### TECHNICAL FIELD

Example embodiments generally relate to power tools for drilling operations and, in particular, relate to a positive feed drill with liftoff protection.

### BACKGROUND

Power tools are commonly used across all aspects of industry and in the homes of consumers. Power tools are employed for multiple applications including, for example, drilling, tightening, sanding, and/or the like. Handheld power tools are often preferred, or even required, for jobs that require a high degree of freedom of movement or access to certain difficult to reach objects. However, other power tools, which are employed in contexts that require high degrees of accuracy, may be affixed to either the surface of a workpiece or to a fixture that attaches to the workpiece in order to ensure greater accuracy. A positive feed drill is an example of such a device.

In some specific industries, such as, but not limited to the aerospace industry, the operation and use of power tools for making precision holes in a structure may be a key part of an assembly process. Positive feed drills are often used in these contexts, and may be attached to the structure (e.g., an aluminum workpiece that forms part of the fuselage of an aircraft), or to a fixture that attaches to the structure.

To affix the positive feed drill to a structure, various attachment mechanisms may be employed. However, if the attachment mechanism fails or is improperly installed, the performance of the positive feed drill can deteriorate or certain operational limits may be exceeded. As a result, the positive feed drill may push away from the structure or may separate from a fixture. This can cause oversized holes, damage to tools, or other problems.

### BRIEF SUMMARY OF SOME EXAMPLES

In an example embodiment, a power tool is provided. The power tool may include a motor powered, a controller configured to control operation of the motor, a drill assembly configured to control operation of a cutter with respect to a workpiece responsive to operation of the motor, and a liftoff protection assembly. The liftoff protection assembly may be configured to detect a trigger event associated with movement of the power tool relative to the workpiece, and initiate a protective action for the power tool responsive to the trigger event.

In another example embodiment, a method of controlling a positive feed drill is provided. The method may include arranging a positive feed drill proximate to a workpiece in a fixed location relative to the workpiece, detecting a trigger event based on a change in locational relationship between the positive feed drill and the workpiece, and, in response to the trigger event, initiating a protective action relative to operation of the positive feed drill.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a block diagram of components that may be employed in a power tool in accordance with an example embodiment;

FIG. 2 illustrates a block diagram of a liftoff protection assembly in accordance with an example embodiment;

FIG. 3 illustrates a pneumatic circuit capable of forming the liftoff protection assembly of an example embodiment;

FIG. 4 illustrates a block diagram of a method of controlling a power tool in accordance with an example embodiment; and

FIG. 5 illustrates one example power tool that may employ the method of FIG. 4 in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As indicated above, separation of a power tool, such as a positive feed drill, from the structure (or fixture) to which it is attached can be problematic. To date, industry response to this problem has been to avoid such separation by increasing the holding power of attachment assemblies. In other words, stronger clamping mechanisms have generally been developed in order to prevent such separation. However, merely forcibly holding the drill in place can cause load limits for the tool itself to be reached. Thus, stronger clamping cannot be seen as a panacea for solving these problems. Some example embodiments may provide a way to detect when a positive feed drill has lost contact with a structure to which it is affixed, or has moved position in the fixture to which it is attached. Either of these situations may be detected as a trigger event. Responsive to detection of the trigger event, example embodiments may further implement a protective action with respect to continued operation of the positive feed drill (or other power tool). The protective action may include, for example, turning off the power tool, retracting the power tool, or returning the power tool to another safe position or condition. Accordingly, example embodiments may enable detection of situations where the power tool is losing contact with the workpiece or coming out of a fixture, and prescribe a protective action when such situations are detected.

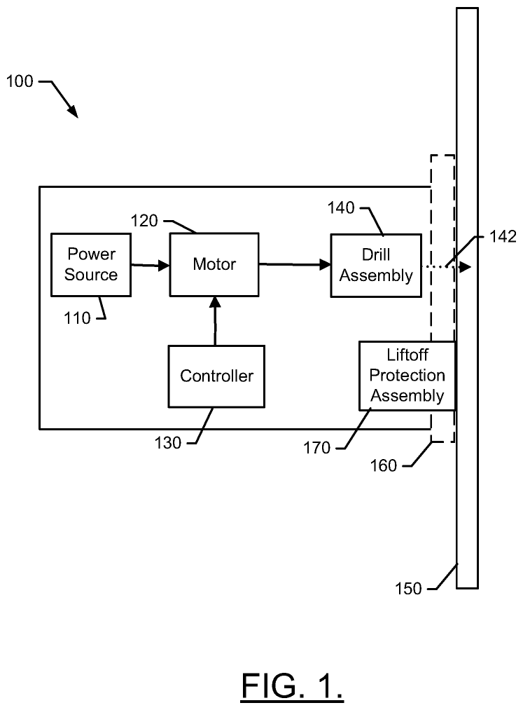

FIG. 1 illustrates a block diagram of components that may be employed in a power tool 100 (e.g., a positive feed drill) in accordance with an example embodiment. As shown in FIG. 1, the power tool 100 may include a power source 110, a motor 120, a controller 130 and a drill assembly 140. The power source 110 may be any suitable power source for the power tool 100 including, for example, an electrical power source (e.g., mains power or a battery), a pneumatic power source, and/or the like. The motor 120 may be an electric motor, a pneumatic motor, or any other suitable motor configurable to drive the components of the drill assembly 140 responsive to control from the controller 130. The controller 130 may include electronic, pneumatic, or other control mechanisms, valves, circuitry, switches and/or the like, which are configured to allow automatic, operator controlled, computer controlled, or other actuation of the motor 120. In some cases, the controller 130 may include a button, trigger, lever or the like that is physically depressed or actuated in order to supply power from the power source 110 to the motor 120 to cause operation of the motor 120. However, other control paradigms are also possible including electronic control from an operating station, computer, or the like.

The drill assembly 140 may include a spindle, gearing, chuck and/or the like, all of which may be configured to enable the drill assembly 140 to drive a cutter 142 relative to a workpiece 150. The power tool 100 may be operably coupled to the workpiece 150 in a manner that is intended to fix the position and location of the power tool 100 relative to the workpiece 150 and/or a hole or opening being formed in the workpiece 150 responsive to operation of the power tool 100. To accomplish this fixing, an attachment assembly 160 may be provided.

The attachment assembly 160 may, in some cases, be a fixture that is attached to the workpiece 150. The fixture may be attached to the workpiece 150 via one or more previously drilled holes in the surface of the workpiece 150, or via other means. Alternatively, the attachment assembly 160 may include any means or device (apart from the fixture mentioned above) that operably couples the power tool 100 to the workpiece 150. The attachment assembly 160 may, for example, directly couple a nose or end face of the power tool 100 (or drill assembly 140) to the workpiece 150 via attachment to a previously drilled hole, or via other fixing means.

In an example embodiment, the power tool 100 may further include a liftoff protection assembly 170 of an example embodiment. The liftoff protection assembly 170 may be configured to detect a trigger event and, responsive to detection of the trigger event, the liftoff protection assembly 170 may be configured to implement a protective action for the power tool 100. The trigger event may include detection of a loss of contact (or losing such contact) between the power tool 100 and either the workpiece 150 or the attachment assembly 160 (e.g., fixture). The protective action may include, for example, turning off the motor 120 (e.g., via the controller 130, cutting power from the power source 110, or by direct intervention with the motor 120). However, as an alternative, the protective action may include retraction of the spindle and the cutter 142. In some cases, stopping of the motor 120 may be initiated after such retraction (thereby combining the two aforementioned examples of protective actions). In another alternative, which may be combined with other actions, or initiated alone, the protective action may include shifting the controller 130 to a different mode of operation in order to place the power tool 100 in a safe condition, or stop the power tool 100 in a phased or stepped approach to bring the power tool 100 to a safe stop.

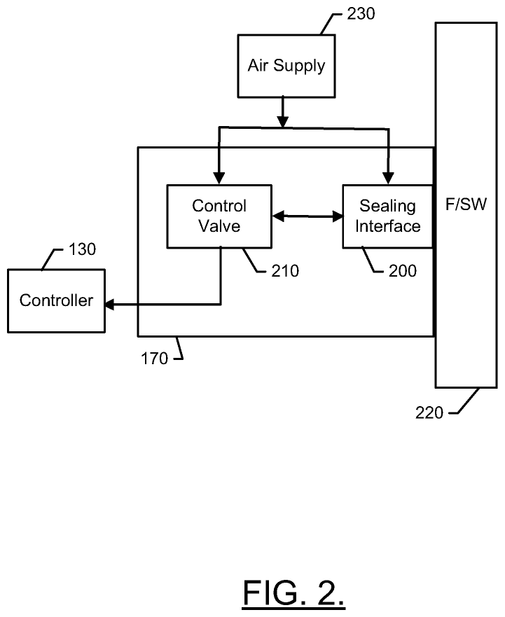

FIG. 2 is a block diagram of the liftoff protection assembly 170 of an example embodiment in which pneumatic power is employed. The liftoff protection assembly 170 of this example may include a sealing interface 200 that is operably coupled to a control valve 210. The sealing interface 200 may be disposed at a fixture or a surface of the workpiece (F/SW) 220 (e.g., attachment assembly 160 of FIG. 1) to define a seal that is sufficient to maintain the desired state of the control valve 210 when the power tool 100 is properly attached to the fixture or the surface of the workpiece 22-. The sealing interface 200 of some embodiments may be an interlocked template boss. Thus, in some cases, the seal may be an airtight seal when the power tool 100 is properly attached to the fixture or the surface of the workpiece 220. However, any other sealing interface capable of detecting movement of the power tool 100 relative to the workspace 220 via mechanically, electrically, or pneumatically determining the trigger event (e.g., the change from the desired state of the control valve 210) and initiating the protective action may alternatively be employed.

Both the sealing interface 200 and the control valve 210 may be exposed to air supply 230 associated with operation of the power tool 100. The control valve 210 may be contact or non-contact type valve that can be normally open or normally closed (depending on the architecture or system design employed). The control valve 210 may be configured to be operable responsive to a change in the sealing state at the sealing interface 200. When operated (e.g., based on a loss of the seal at the sealing interface 200), the control valve 210 may cause the controller 130 (or motor) to initiate a protective action.

In this regard, for example, if the sealing interface 200 is compromised due to movement of the power tool 100 relative to the fixture or the surface of the workpiece 220, the sealing interface 200 may be configured to lose its sealing capability, and such loss of sealing capability may be detected by the control valve 210. The detection of the loss of sealing capability of the sealing interface 200 may therefore be a trigger event that is detected at the control valve 210. The detection of the trigger event by the control valve 210 may then change a state of the control valve 210 to cause the control valve 210 to provide an input to the controller 130 (or directly to the motor 120 or cut off power from the power supply 110) to initiate the protective action for the power tool 100.

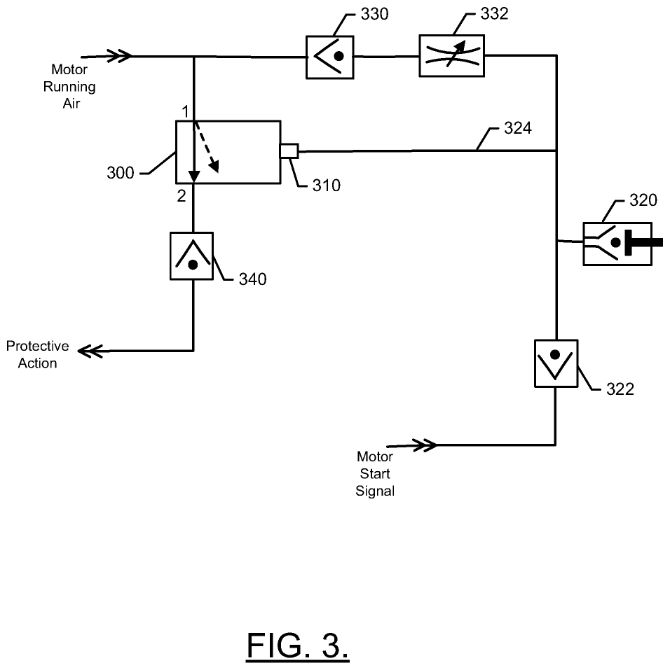

FIG. 3 illustrates a schematic diagram of a circuit that may be configured to implement the liftoff protection assembly 170 of an example embodiment. As shown in FIG. 3, the circuit may include a three way pneumatic control valve 300. The three way pneumatic control valve 300 is an example of the control valve 210 of FIG. 2. The three way pneumatic control valve 300 of this example is a normally open valve having terminals 1 and 2, which are therefore normally connected. The three way pneumatic control valve 300 also includes an actuator 310 that, when actuated, causes terminals 1 and 2 to be disconnected. Accordingly, the solid line (extending from terminal 1, to terminal 2) of FIG. 3 represents the normal condition when the actuator 310 has not been actuated. However, when the actuator 310 is actuated, then the terminals 1 and 2 are connected disconnected as shown by the dashed line connecting them in FIG. 3.

The sealing interface 200 of FIG. 2 may include a template boss 320, which may form a physical seal with either a fixture or a workpiece. When contact between the template boss 320 and the fixture or workpiece is broken, or becomes compromised, the seal of the template boss 320 may be broken and air may escape through the template boss 320. However, under normal circumstances, the template boss 320 may form a seal that prevents air from leaking or otherwise passing through the template boss 320.

When the power tool 100 is operated, the controller 130 of FIG. 1 may initiate a motor start signal and air may be applied to the motor 120 and to the template boss 320 through check valve 322 shown in FIG. 3. The seal may be formed at the template boss 320 by the air pressure provided, which may build up in charging line 324. The actuator 310 may feel an increase in pressure in the charging line 324 and shift to (or stay in) an unactuated (or deactivated) state, which maintains the three way pneumatic control valve 300 closed (so there is no flow possible from terminal 1 to terminal 2). Thereafter, motor running air may also be provided to terminal 1 and to a check valve 330. The motor running air may pass through the check valve 330 and an adjustable flow restrictor 332 (e.g., an adjustable orifice) to reach both the template boss 320 and the actuator 310, thereby maintaining pressure in the charging line 324 so that the actuator 310 remains unactuated (or deactivated) and no air flow is permitted from terminal 1 to terminal 2. With no flow of air to terminal 2, there is also no flow of air through check valve 340.

If the power tool 100 moves relative to the fixture or workpiece, the template boss 320 may lose its seal. When the seal is broken or lost at the template boss 320, air may escape from the charging line 324 and pressure in the charging line 324 may be reduced. The reduction in pressure in the charging line 324 may actuate (or activate) the actuator 310 and cause the closed switch position between terminals 1 and 2 to shift to an open position, thereby connecting terminal 1 to terminal 2. The connection of terminal 1 to terminal 2 enables the motor running air to pass through the check valve 340 and trigger a protective action. Thus, the breaking of the seal of the template boss 320 is detected by the three way pneumatic control valve 300 as a trigger event, and the trigger event causes the three way pneumatic control valve 300 to initiate the protective action by taking a passageway (from terminal 1 to terminal 2) that was blocked, and opening or unblocking the passageway to allow air to flow through and initiate the protective action.

The three way pneumatic control valve 300 of this example is a normally open valve (i.e., open so that the passageway from terminal 1 to terminal 2 is not formed, or is blocked). However, as noted above, it may also be possible to implement a circuit that uses a normally closed valve. The actuation of the actuator 310 on low pressure could similarly be reversed to initiate on a high pressure. It may also be possible to implement a circuit that uses normally open or normally closed two way valves. It may also be possible to eliminate the template boss 320 and charging line 324 and allow actuator 310 to directly contact the workpiece. In such an example, the actuator itself may contact the workpiece thereby providing a mechanical system (instead of the pneumatic system described in the example of FIG. 3). Thus, for example, the template boss 320, the charging line 324 and the actuator 310 of the pneumatic system of FIG. 3 would be replaced with a single mechanical actuator contacting the surface of the workpiece. Accordingly, it can be appreciated that various other changes to the circuitry can also be envisioned by one of skill in the art. However, the basic principle in all cases is to detect movement of the power tool 100 relative to the workpiece or fixture as a trigger event, and then initiate a protective action responsive to the trigger event. Thus, instead of a pneumatic circuit, as shown in FIG. 3, an electric circuit could alternatively be used.

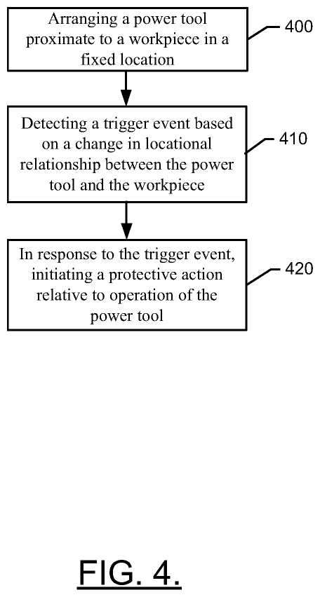

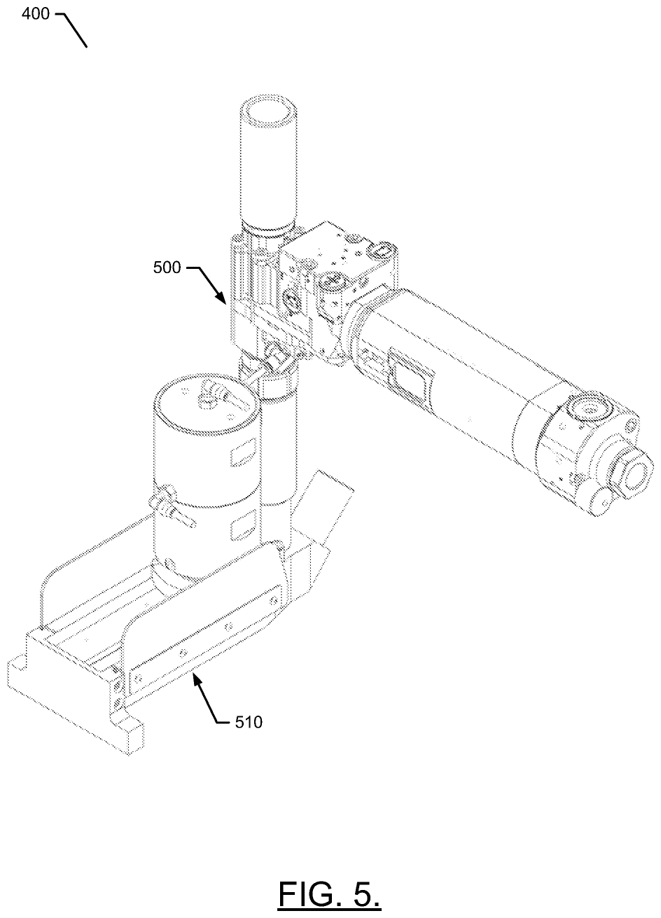

FIG. 4 illustrates a block diagram of a method of controlling a power tool (e.g., a positive feed drill) in accordance with an example embodiment. In this regard, the method may include arranging a power tool proximate to a workpiece in a fixed location at operation 400. The method may further include detecting a trigger event based on a change in locational relationship between the power tool and the workpiece (e.g., based on movement of the power tool relative to the workpiece or a fixture) at operation 410. In response to the trigger event, initiating a protective action relative to operation of the power tool at operation 420. As noted above, the protective action may be stopping the power tool, retracting the spindle and/or cutter, or changing an operational mode of the power tool. FIG. 5 illustrates a perspective view of a power tool 500 and a fixture 510 that may employ an example embodiment, and which may be configured to perform the method of FIG. 4.

Accordingly, example embodiments may provide the ability to detect an movement of a positive feed drill after it has been clamped or otherwise fixed in place relative to a workpiece (e.g., via a fixture). When such movement is detected, the drill may be returned to a safe and/or stopped position to avoid damage to either the workpiece or the drill itself.

A power tool (e.g., a positive feed drill) of an example embodiment may include a power source (e.g., electric or pneumatic), a motor powered from the power source, a controller configured to control operation of the motor, a drill assembly configured to control operation of a cutter with respect to a workpiece responsive to operation of the motor, and a liftoff protection assembly. The liftoff protection assembly may be configured to detect a trigger event associated with movement of the power tool relative to the workpiece, and initiate a protective action for the power tool responsive to the trigger event.

In some embodiments, additional optional features may be included or the features described above may be modified or augmented. Each of the additional features, modification or augmentations may be practiced in combination with the features above and/or in combination with each other. Thus, some, all or none of the additional features, modification or augmentations may be utilized in some embodiments. For example, in some cases, the liftoff protection assembly may include a sealing interface and a control valve. The sealing interface may be configured to form a breakable seal at a surface of the workpiece or a fixture attached to the workpiece. The seal may be broken responsive to movement of the power tool relative to the workpiece. The control valve may be configured to detect the trigger event based on a status of the sealing interface and initiate the protective action responsive to the trigger event. In an example embodiment, the sealing interface may include a template boss configured to prevent air passage when the seal is not broken and to release air responsive to breaking the seal at the surface of the workpiece or the fixture attached to the workpiece. In some cases, the control valve may include a three way pneumatic control valve. In an example embodiment, the three way pneumatic control valve may include a normally blocked air passageway and may be configured, responsive to detecting the trigger event, to unblock the passageway to define an airflow for initiating the protective action. In some cases, the three way pneumatic control valve may include an actuator operably coupled to a charging line. Actuation of the actuator may define the trigger event, and the actuator may be configured to be actuated responsive to a change in air pressure in the charging line. In some cases the charging line may be eliminated an the pneumatic control valve my directly detect the trigger event. In an example embodiment, the protective action may include stopping the motor, removing the cutter from the workpiece, removing the cutter from the workpiece and then stopping the motor, or changing an operational mode of the power tool during extraction of the cutter from the workpiece. In some cases, the liftoff assembly may include a pneumatic circuit configured to detect the trigger event as a change in pressure, and initiate the protective action by initiating control of the motor.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed :

1. A power tool comprising:
a motor;
a controller configured to control operation of the motor;
a drill assembly configured to control operation of a cutter with respect to a workpiece responsive to operation of the motor; and
a liftoff protection assembly configured to detect a trigger event associated with movement of the power tool relative to the workpiece, and initiate a protective action for the power tool responsive to the trigger event.

2. The power tool of claim 1, wherein the liftoff protection assembly comprises:
a sealing interface configured to form a breakable seal at a surface of the workpiece or a fixture attached to the workpiece, the seal being broken responsive to movement of the power tool relative to the workpiece; and
a control valve configured to detect the trigger event based on a status of the sealing interface and initiate the protective action responsive to the trigger event.

3. The power tool of claim 2, wherein the sealing interface comprises a template boss configured to prevent air passage when the seal is not broken and to release air responsive to breaking the seal at the surface of the workpiece or the fixture attached to the workpiece.

4. The power tool of claim 3, wherein the control valve comprises a three way or two way pneumatic control valve.

5. The power tool of claim 4, wherein the three way pneumatic control valve comprises a normally blocked air passageway and is configured, responsive to detecting the trigger event, to unblock the passageway to define an airflow for initiating the protective action.

6. The power tool of claim 5, wherein the three way pneumatic control valve comprises an actuator operably coupled to a charging line,
wherein actuation of the actuator comprises the trigger event, and
wherein the actuator is configured to be actuated responsive to a change in pressure in the charging line.

7. The power tool of claim 1, wherein the protective action comprises stopping the motor.

8. The power tool of claim 1, wherein the protective action comprises removing the cutter from the workpiece.

9. The power tool of claim 1, wherein the protective action comprises removing 15 the cutter from the workpiece and then stopping the motor.

10. The power tool of claim 1, wherein the protective action comprises changing an operational mode of the power tool during extraction of the cutter from the workpiece.

11. The power tool of claim 1, wherein the liftoff assembly comprises a pneumatic circuit configured to detect the trigger event as a change in pressure, and initiate the protective action by initiating control of the motor.

12. The power tool of claim 1, wherein the power tool comprises a positive feed drill.

13. A method of controlling a positive feed drill, the method comprising:
arranging a positive feed drill proximate to a workpiece in a fixed location relative to the workpiece;
detecting a trigger event based on a change in locational relationship between the positive feed drill and the workpiece; and
in response to the trigger event, initiating a protective action relative to operation of the positive feed drill.

14. The method of claim 13, wherein detecting the trigger event comprises detecting the change in locational relationship based on movement of the positive feed drill relative to a fixture to which the workpiece is attached.

15. The method of claim 13, wherein initiating the protective action comprises stopping a motor of the positive feed drill.

16. The method of claim 13, wherein initiating the protective action comprises removing a cutter of the positive feed drill from the workpiece.

17. The method of claim 13, wherein initiating the protective action comprises removing a cutter of the positive feed drill from the workpiece and then stopping a motor of the positive feed drill.

18. The method of claim 13, wherein initiating the protective action comprises changing an operational mode of the positive feed drill during extraction of a cutter of the positive feed drill from the workpiece.

19. The method of claim 13, wherein arranging the positive feed drill proximate to the workpiece comprises forming a sealing interface at a surface of the workpiece or a fixture attached to the workpiece, the sealing interface comprising a breakable seal configured to be broken responsive to movement of the positive feed drill relative to the workpiece or the fixture.

20. The method of claim 19, wherein detecting the trigger event comprises detecting a change in pressure due to breaking of the seal at the sealing interface.
